(19) United States
(12) Patent Application Publication
(10) Pub. No.: US 2003/0093649 A1
(43) Pub. Date: May 15, 2003

(54) Flexible caching of translated code under emulation

(76) Inventor: Ronald Hilton, San Francisco, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/992,121

(22) Filed: Nov. 14, 2001

(51) Int. Cl. G06F 15/00; G06F 9/45

(52) U.S. Cl. 712/41; 717/138

(57) ABSTRACT

Emulation of a guest computer architecture on a host system of another computer architecture. The guest computer architecture has programs composed of legacy instructions. To perform the emulation of the legacy instructions on the host system, the legacy instructions are accessed in the host system. Each particular legacy instruction is translated into one or more particular translated instructions for emulating the particular legacy instruction. RISC blocks translated from CISC blocks are held in system memory cache. The efficiency of translation of CISC blocks to RISC blocks in the cache is improved by using small-, equal-sized RISC blocks that are linked into a logical entity. The logical entity is a linked group of one or more RISC blocks logically linked for each CISC block. The logical links from one RISC block to another RISC block are implemented by a linked-list.

### BACKGROUND OF THE INVENTION

The present invention relates to computer systems and particularly to emulation of one computer architecture (the “guest”) via software on the hardware platform of another computer architecture (the “host”).

In typical computer architectures, computer source code is compiled/assembled (at compile/assembly time) into executable object code. The executable object code is executed at execution time on the hardware under control of the operating system. In order for computer source code written for a native architecture to run as a “guest” on a different architecture called a “host” architecture, the host architecture employs an emulator. The emulator emulates the native architecture while actually executing as a guest on the host architecture.

Various methods have been employed for emulating a guest computer architecture via software on the hardware platform of a host computer architecture. The categories of emulation are static emulation or dynamic emulation. In static emulation, the emulation is performed prior to run-time and in dynamic emulation, the emulation is performed at run-time.

One type of static emulation system employs object code translation. The native object code that is compiled/assembled for a native system becomes the guest object code on a host system. The guest object code is translated in a manner that is similar to the way that original source code is compiled/assembled into the object code for the native system. In the emulation case, however, rather than starting with the original source code, the emulation starts with the previously compiled/assembled object code as prepared for the native system. The guest object code (the native object code on the host system) is passed through an emulator to form the translated object code. The translated object code is suitable for execution directly by the host system. Essentially, static emulation is a method of recompiling the native object code without using the original source code. The advantage of such static emulation is that the resulting translated object code can be optimized in much the same way that native object code is optimized when native object code is compiled/assembled from original source code. Unfortunately, it is not always possible to glean all the necessary information statically from the native object code alone that was available when the original source code was compiled/assembled from original source code.

Another method of static emulation is Application Programming Interface (API) mapping. This method of static emulation only applies to operating system code in which the API calls of the guest operating system are mapped to a host call or set of host calls that perform the equivalent function on the host system. The API mapping has a performance advantage since the host operating system software has been optimized for the host system. However, if the native and host systems are too dissimilar, then the desired mapping may not always be possible. Nevertheless, API mapping is a useful method for providing some degree of equivalent operating system functionality when used in conjunction with other forms of static or dynamic emulation.

Dynamic emulation is performed during run time. The main advantage of dynamic emulation is greater transparency to the user in that no pre-processing need be invoked by the user as is required for static emulation. A simple type of dynamic emulation uses an interpreter which fetches, parses, and decodes each guest instruction and responsively executes a routine to carry out the equivalent functions on the host system. The main disadvantage of an interpreter is one of low performance because of the significant overhead involved in processing every guest instruction each time it is executed. To mitigate the disadvantage of that overhead, a more advanced method of dynamic emulation sometimes called “JIT” (just-in-time) translation is employed.

In JIT dynamic emulation, the native object code is translated (similar to the static method), cached, and executed in piecemeal fashion, a small portion at a time. By translating only a small portion of guest object code that is likely to be executed next, the translation is performed in real time, essentially concurrently with the execution of the translated code. The translated code is cached (that is, is saved) to permit subsequent re-use without the need for re-translation. The initial translation overhead is therefore amortized over time, allowing the overall performance to approach that of static object code translation, especially within the most frequently used portions of the code. By using additional information regarding program behavior that can be gleaned at run-time, it is possible to optimize the translated code to obtain performance beyond that achievable with static translation alone.

Emulation frequently is used when a CISC architecture is emulated on a RISC architecture. For a typical translation of CISC blocks of code to RISC blocks of code, a one-to-one correspondence exists between CISC blocks and translated RISC blocks. In a translation, the RISC blocks are held in a cache structure in memory to permit RISC blocks to be associated with the CISC blocks from which they are translated. The CISC blocks, being defined using a preselected subset of the host address, are equal in size. However, the amount of RISC code generated for any particular CISC block need not be the same as the amount of code generated for another particular CISC block. Although caching can be simplified if the RISC blocks are all of equal size, such equal sizing must be selected large enough to avoid overflow for translation of any CISC. To avoid overflow using RISC blocks of equal size, the size for all of the RISC blocks must be large enough to store the translated code for the largest translated RISC block. When such uniform block size is selected for the largest RISC block, a large amount of wasted memory space results since the largest RISC block is much greater in size than the smallest, and the average, RISC block size.

In order to take advantage of dynamic emulation, there is a need for improved dynamic emulators that help achieve the objectives of improved and more efficient computer system operation, particularly in the processing of blocks of CISC code that create translated RISC blocks of code of varying sizes.

### SUMMARY

The present invention is for emulation of a guest computer architecture on a host system of another computer architecture. The guest computer architecture has programs composed of legacy instructions. To perform the emulation of the legacy instructions on the host system, the legacy instructions are accessed in the host system. Each particular legacy instruction is translated into one or more particular translated instructions for emulating the particular legacy instruction. Typically, RISC blocks translated from CISC blocks are held in system memory cache. The efficiency of translation of CISC blocks to RISC blocks in the cache is improved by using small-sized and equal-sized RISC blocks that are linked into a logical entity. The logical entity is a linked group of one or more RISC blocks for each CISC block logically linked. The logical links from one RISC block to another RISC block are implemented, for example, by a linked-list structure.

Each CISC block maps to a group of one or more linked RISC blocks. Each group of linked RISC blocks corresponds to at least one CISC block. Besides utilizing memory more efficiently, the logical linking of RISC blocks has a performance advantage. By combining several RISC blocks into a single logical entity, the need to invoke the XFER_SEQUENTIAL and XFER_TARGET look-up functions in translated RISC blocks is greatly reduced. Rather than use a XFER_SEQUENTIAL look-up function at the end of RISC blocks, the RISC code at the end of RISC blocks simply branches directly to the next RISC block which itself is within the same group of linked RISC blocks.

Where taken branches in RISC blocks are within the same logical entity, the taken branches are made directly rather than invoking XFER_TARGET. Such direct branching between RISC blocks in the same logical entity is possible because none of the RISC blocks in the same logical entity are susceptible of independent removal from the cache. The linked RISC blocks are processed as a single, cohesive group and hence they better reflect the logical structure and relationships of the original CISC code, regardless of arbitrary physical boundaries in the RISC cache memory.

In a typical embodiment, the legacy instructions are for a legacy system having a S/390 architecture and the legacy instructions are object code instructions compiled/assembled for the S/390 system and the translated instructions are for execution in a RISC architecture.

The foregoing and other objects, features and advantages of the invention will be apparent from the following detailed description in conjunction with the drawings.

### BRIEF DESCRIPTION OF THE DRAWINGS

FIG. 1 depicts a block diagram of a complex of computer systems including a native computer system and a number of computer systems for emulating the native computer system.

FIG. 2 depicts a block diagram of one emulator in the complex of FIG. 1 for emulating the native computer system of FIG. 1.

FIG. 3 depicts an example of one type of dynamic emulation in the FIG. 1 complex.

FIG. 4 depicts a detailed example of improved dynamic emulation based upon flexible caching that employs groups of blocks of translated RISC instructions in cache locations linked using a linked list architecture.

FIG. 5 depicts an expanded example, including the FIG. 4 example, of improved dynamic emulation based upon flexible caching that employs groups of blocks of translated RISC instructions in cache locations linked using a linked list architecture.

### DETAILED DESCRIPTION

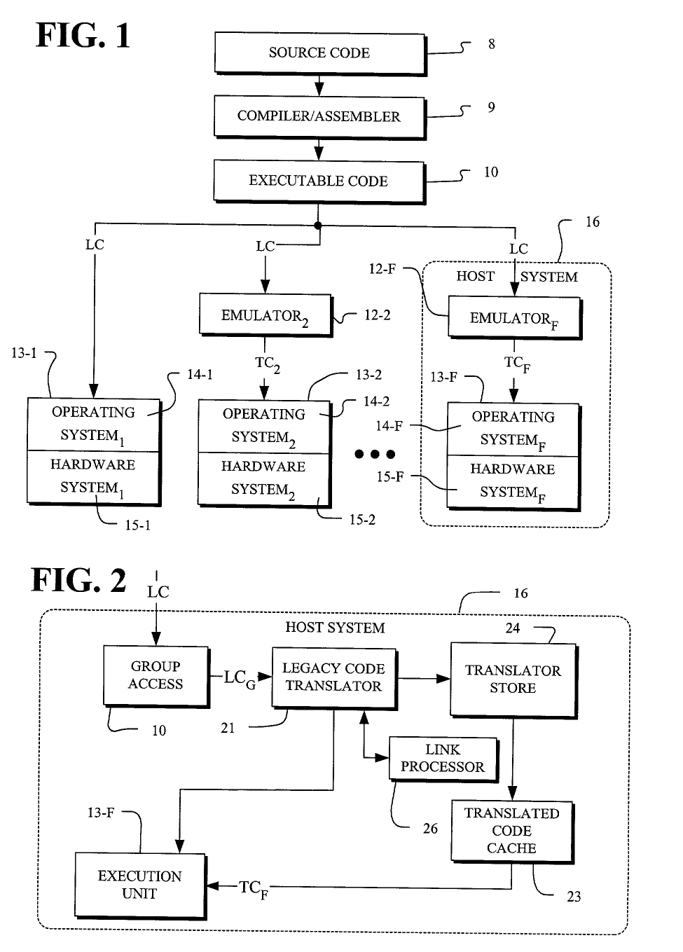

In FIG. 1, a complex of computer systems 13, including computer systems 13-1, 13-2, . . . , 13-F, is presented where the target computer systems 13-2, . . . , 13-F use translated code for emulating the native computer system 13-1. The computer systems 13-1,13-2, . . . , 13-F are shown in a complex, each receiving the same executable codes. Typically, each of the computer systems 13-1, 13-2, . . . , 13-F is a stand-alone system and not in the same complex. The computer systems 13-1, 13-2, . . . , 13-F are organized as having a operating systems 14-1, 14-2, . . . , 14-F, respectively, and having hardware systems 15-1, 15-2, . . . , 15-F, respectively. In FIG. 1, the host system 16, in a typical embodiment, is a stand-alone system which receives executable legacy code 10 as an input.

For the computer systems 13 of FIG. 1, source code 8, programmed in a convenient language, represents many application and other programs that collectively constitute a large investment in time and knowledge for owners of native computer systems. The native system 13-1 has available well-perfected compilers/assemblers 9 for forming native executable code 11 (legacy code) that efficiently executes application and other programs on the native system 13-1. For the computer systems 13-2, . . . , 13-F, however, well-perfected compilers/assemblers may not be available or, even if available, the source code 8 may not always be available. In order to help preserve the investment in the application and other programs of the native computer system, emulators are employed to execute the executable legacy code on one or more of the target computer systems 13-2, . . . , 13-F. Typically, the target computer systems 13-2, . . . , 13-F are new computer systems that have a different architecture. The objective is to preserve the investment in the application and other programs of the native architecture by enabling them to execute by emulation on the target computer systems.

In FIG. 1, the native executable code 10 is used directly in the computer system 13-1 according to the native architecture which includes a native operating system 14-1 and a native hardware system 15-1. Also, the native executable code 10 is processed by the emulator 12-2 to produce translated code, TC₂, for execution by the target system 13-2 according to an architecture different from the native architecture and which includes an operating system 14-2 and a hardware system 15-2. Similarly, the native executable code 10 is processed by the emulator 12-F to produce translated code, TCF, for execution by the target system 13-F according to an architecture different from the native architecture and which includes an operating system 14-F and a hardware system 15-F.

In FIG. 2, further details of the host system 16 of FIG. 1 are shown. The group access unit accesses legacy code (LC) and presents the legacy code in groups (LC_{G}) to a legacy code translator 21. The legacy code translator 21 stores detailed information about the translation in translation store 24. The legacy code translator 21 also stores the executable blocks of host code in a translated code (TC) cache 23. The link processor 26 functions to dynamically link equal-sized blocks of translated code.

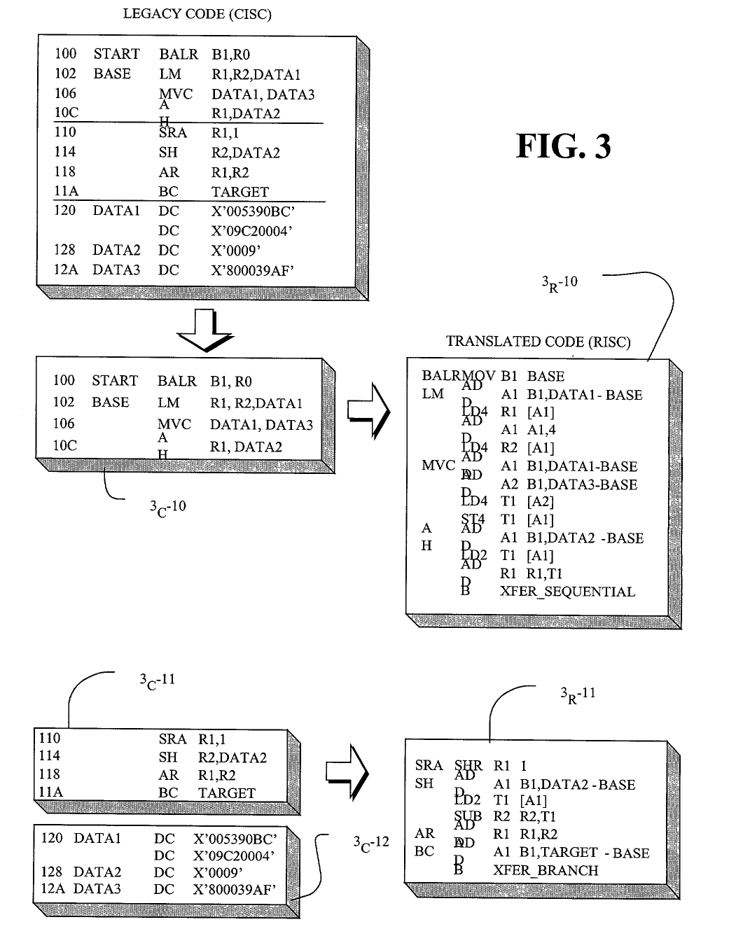

A typical example of a known emulation is illustrated in FIG. 3. In this example, legacy code is being translated to translated code where the legacy code is complex instruction set code (CISC) for a CISC architecture computer system and the translated code is reduced instruction set code (RISC) for a RISC architecture computer system. In the FIG. 3 example, the legacy code is for the S/390 architecture. In the example, the code has been simplified for purposes of clarity of explanation. The same principles apply to translations from any given architecture to any other architecture.

In FIG. 3, a typical example of CISC legacy code consists of eight S/390 instructions (with hexadecimal instruction byte addresses 100, 102, 106, 10C, 110, 114, 118 and 11A) followed by 14 bytes of operand data (with hexadecimal byte addresses 120, 128, 12A) for a total of 44 bytes. The first step in the translation is to access the legacy code blocks. In the example, there are three 16-byte aligned blocks (a first block at addresses 100, 102, 106, 10C; a second block at addresses 110, 114, 118, 11A; and a third block at addresses 120, 128, 12A). Each CISC block is translated into a block of corresponding RISC code by translating each CISC instruction in a block in order. One or more RISC instructions are required to perform the equivalent function of each CISC instruction depending on the degree of complexity of each CISC instruction.

In the example of FIG. 3, the CISC instructions BALR, SRA, and AR each require only one RISC instruction, the CISC instructions AH and SH require three RISC instructions, and the CISC instructions LM and MVC require four RISC instructions. The third CISC block (with addresses 120, 128, 12A) consists solely of operand data and does not require translation. The blocks of RISC translated code emitted from the emulation are executed by the target computer system 13-2 of FIG. 1. In typical translation operation, a transfer routine is called at the end of each RISC block to locate the next block. At the end of the first block, XFER_SEQUENTIAL is called to look up the cache location of the RISC block corresponding to the next sequential CISC address (110 in the example). The second block ends in a branch (BC), and therefore calls XFER_TARGET to perform the analogous look-up function for the CISC branch target address.

The FIG. 3 example includes S/390 CISC instructions organized in CISC blocks including, for example, three CISC blocks 3_{C}-10, 3_{C}-12 and 3_{C}-12. For a typical translation of the FIG. 3 CISC blocks as shown in FIG. 3, a one-to-one correspondence exists between CISC blocks and translated RISC blocks. The translated RISC blocks 3_{R}-10 and 3_{R}-11 correspond to the CISC blocks 3_{C}-10 and 3_{C}-11, respectively, while 3_{C}-12 is not translated because it contains only data. After translation, the RISC blocks 3_{R}-10 and 3_{R}-11 are held in the cache memory designated in FIG. 3 as TRANSLATED CODE (RISC). Storage in the cache memory permits the translated RISC blocks 3_{R}-10 and 3_{R}-11 to be associated with the CISC blocks 3_{C}-10 and 3_{C}-11 from which they are translated. The CISC blocks 3_{C}-10 and 3_{C}-11 are defined using a preselected subset of the host address and hence are equal in size. However, the amount of RISC code generated for one CISC block need not be the same as the amount of RISC code generated for another CISC block. Note, for example, the size of the translated RISC block 3_{R}-10 is much larger than the size of the corresponding CISC block 3_{C}-10. Similarly, the size of the translated RISC block 3_{R}-11 is not much greater than the size of the corresponding CISC block 3_{C}-11.

In FIG. 3, in order to avoid overflow if RISC blocks of equal size were employed, the size for all of the RISC blocks would need to be large enough to store the translated code for the largest translated RISC block. In FIG. 3, RISC block 3_{C}-10 is largest. Such use of the largest block size would result in a great deal of wasted memory space since typically the largest RISC block size is much greater than the average RISC block size for typical translations.

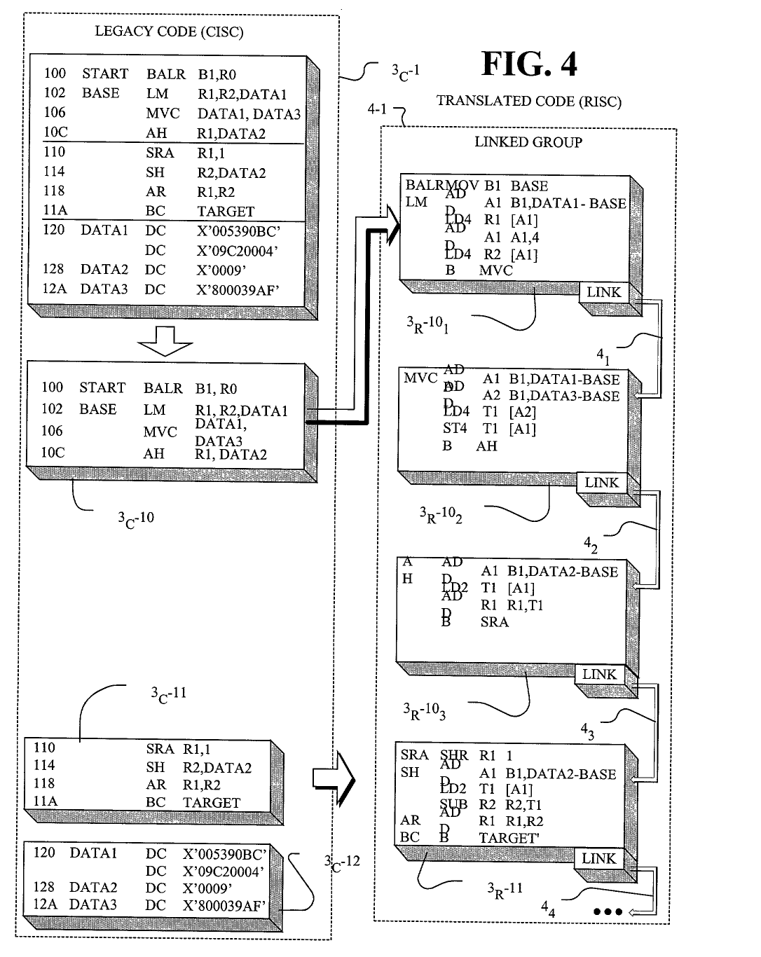

FIG. 4 depicts an example of improved dynamic emulation based upon flexible caching that employs groups of small blocks of translated RISC instructions in linked cache locations.

The FIG. 4 example includes the S/390 CISC instructions of FIG. 3 organized in CISC blocks including, for example, the three CISC blocks 3_{C}-10, 3_{C}-11 and 3_{C}-12. The CISC blocks 3_{C}-10, 3_{C}-11 and 3_{C}-12 are defined using a preselected subset of the host address and hence are equal in size. Unlike FIG. 3, a translation of the CISC blocks in FIG. 4 does not have a one-to-one correspondence to the translated RISC blocks. The translated RISC blocks 3_{R}-10₁, 3_{R}-10₂ and 3_{R}-10₃ all correspond to the CISC blocks 3_{C}-10. The translated RISC block 3_{R}-11 corresponds to the CISC block 3_{C}-11. After translation, the RISC blocks 3_{R}-10₁, 3_{R}-10₂ and 3_{R}-10₃ and 3_{R}-11 are held in the cache represented in FIG. 4 as TRANSLATED CODE (RISC). The translated RISC blocks 3_{R}-10₁, 3_{R}-10₂ and 3_{R}-10₃ and 3_{R}-11 stored in cache are associated with the CISC blocks 3_{C}-10 and 3_{C}-11 from which they are translated. However, note in FIG. 4 that the number of RISC blocks of code generated for one CISC block of code is variable. The number of RISC blocks per CISC block changes as a function of the complexity of the CISC code in the CISC block being translated. The size of each of the translated RISC blocks 3_{R}-10₁, 3_{R}-10₂ and 3_{R}-10₃and 3_{R}-11 are the same.

In FIG. 4, the translated RISC blocks 3_{R}-10₁, 3_{R}-10₂ and 3_{R}-10₃ and 3_{R}-11 are all logically linked in a link group 4-1. The logical linking in link group 4-1 uses a linked list whereby the first RISC code block 3_{R}-10₁ includes a link 4₁ that points to the location in the cache of the next RISC block 3_{R}-10₂. Similarly, the RISC code block 3_{R}-10₂ includes a link 4₂that points to the location in the cache of the next RISC block 3_{R}-10₃. Finally, the RISC code block 3_{R}-10₃ includes a link 4₃ that points to the location in the cache of the next RISC block 3_{R}-11. The RISC block 3_{R}-11 in turn may point to still additional subsequent translated RISC blocks (not shown) with a link 4₄.

The FIG. 4 emulation improves the efficiency of translation of CISC blocks to RISC blocks held in a cache by using small-sized RISC blocks 3_{R}-10₁, 3_{R}-10₂ and 3_{R}-10₃ and 3_{R}-11 linked into a single logical entity 4-1. The logical entity 4-1 includes the group of RISC blocks 3_{R}-10_{1, 3}_{R}-10₂ and 3_{R}-10₃ and 3_{R}-11 logically linked by links 4₁, 4₂, 4₃ and so on where the logical links are implemented by a linked list where the link in one RISC block points to the cache location of the next RISC block. Each group of linked RISC blocks corresponds to one or more CISC blocks. Besides utilizing memory more efficiently, the logical linking of RISC blocks has a performance advantage that can be observed by the absence in FIG. 4 of the XFER_SEQUENTIAL look-up function used in FIG. 3. Rather than use XFER_SEQUENTIAL or XFER_TARGET look-up functions at the end of RISC blocks as required in the FIG. 3, the RISC code of FIG. 4 simply branches directly to the next RISC block as shown, for example, by the branch (B) to SRA instruction in RISC block 3_{R}-10₃. The branch (B) to SRA instruction in RISC block 3_{R}-10₃ avoids the XFER_SEQUENTIAL instruction at the end of RISC block 3_{R}-10 in FIG. 3.

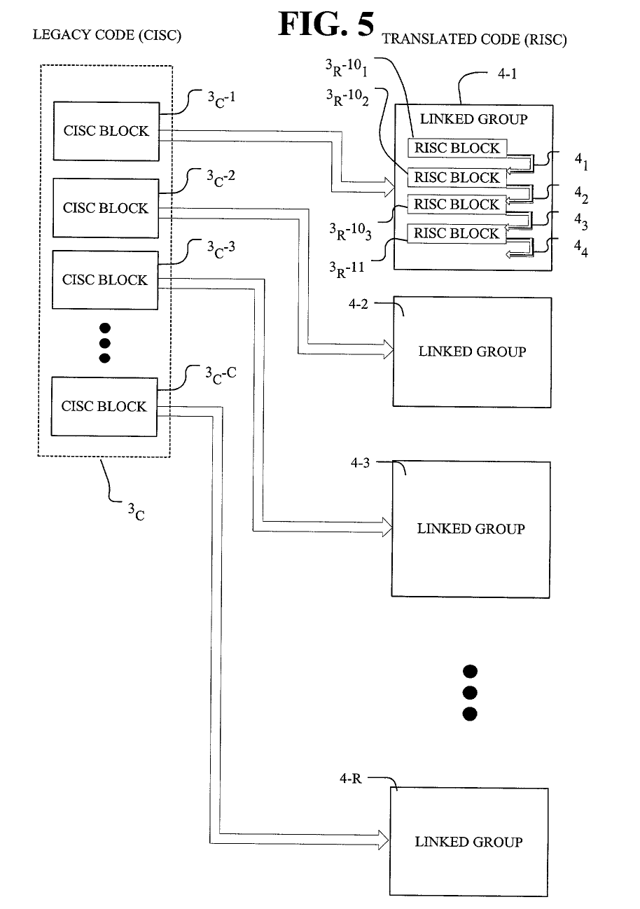

FIG. 5 depicts an expanded example, including the FIG. 4 example, of improved dynamic emulation based upon flexible caching. In FIG. 5, the legacy code 3_{C}-1 corresponds to the three CISC blocks 3_{C}-10, 3_{C}-11 and 3_{C}-12. The CISC blocks 3_{C}-10 and 3_{C}-11 are translated to the linked group 4-1 including the linked RISC blocks 3_{R}-10₁, 3_{R}-10₂ and 3₃ and 3_{R}-11. In general, the legacy code 3_{C} of FIG. 5 includes the legacy code blocks 3_{C}-1, 3_{C}-2, 3_{C}-3, . . . , 3_{C}-C where each of the legacy blocks is the same size. Each of the legacy code blocks 3_{C}-1, 3_{C}-2, 3_{C}-3, . . . , 3_{C}-C in turn is translated to a corresponding linked group of RISC blocks including linked groups 4-1, 4-2, 4-3, . . . , 4-R, respectively. The number of RISC blocks in each linked group is varied as a function of complexity of the CISC block translated.

In FIG. 5, some CISC instructions are branch instructions that are translated to RISC branch instructions. When a RISC instruction is a taken branch, the branch can be taken directly if the branch target location is within the same linked group of RISC blocks. For example, a taken branch in any RISC block of linked group 4-2 can branch directly to any RISC block also in linked group 4-2. Direct branching between RISC blocks in the same logical entity is possible because since each RISC block is part of the same logical entity it will not be independently removed from the cache separate from the other RISC blocks of that same logical entity. The ability to link RISC blocks together as a single, cohesive unit allows them to better reflect the logical structure and relationships of the original CISC code, regardless of arbitrary physical boundaries

While the invention has been particularly shown and described with reference to preferred embodiments thereof it will be understood by those skilled in the art that various changes in form and details maybe made therein without departing from the scope of the invention.

1. (Original) A method for dynamic emulation of legacy instructions comprising:
accessing said legacy instructions in legacy blocks,
for each particular legacy instruction in a particular legacy block,
translating the particular legacy instruction into one or more particular translated instructions for emulating the particular legacy instruction,
organizing the particular translated instructions into one or more particular translated blocks,
linking the particular translated blocks into a particular linked group corresponding to said particular legacy instruction.

2. (Original) The method of claim 1 wherein said linking step uses a link in each particular translated block to point to a location of the next particular translated block of the particular linked group.

3. (Original) The method of claim 1 wherein said particular translated instructions are stored in a cache and wherein said particular translated instructions are purged from said cache only when all said particular translated instructions of particular translated blocks are also purged from said cache.

4. (Original) The method of claim 1 wherein said legacy instructions are for a legacy system having a S/390 architecture.

5. (Original) The method of claim 1 wherein said legacy instructions are object code instructions compiled/assembled for a legacy architecture.

6. (Original) The method of claim 1 wherein said translated instructions are for execution in a RISC architecture.

7. (Original) A method for dynamic emulation of legacy instructions, where the legacy instructions are compiled/assembled into object code form for a native architecture, where the legacy instructions are executed as guests in the host architecture, where the legacy instructions are translated to translated instructions in the host architecture and the translated instructions are executed in the host architecture concurrently with the translation of the legacy instructions in the host architecture, comprising:
accessing said legacy instructions in legacy blocks of a host system operating with said host architecture,
for each particular legacy instruction in a particular legacy block,
translating the particular legacy instruction into one or more particular translated instructions of the host system for emulating the particular legacy instruction as a guest in said host architecture,
organizing the particular translated instructions into one or more particular translated blocks,
linking the particular translated blocks into a particular linked group corresponding to said particular legacy instruction.
